(19) United States
(12) Patent Application Publication
(10) Pub. No.: US 2025/0033226 A1
(43) Pub. Date: Jan. 30, 2025

(54) GRIP MEMBER FOR A VACUUM BOX

(71) Applicant: COVAL, MONTELIER (FR)

(72) Inventor: Loic JOGUET, MONTELIER (FR)

(21) Appl. No.: 18/780,667

(22) Filed: Jul. 23, 2024

(30) Foreign Application Priority Data
Jul. 25, 2023 (FR) FR2308020

(51) Int. Cl. B25J 15/06

(52) U.S. Cl. CPC B25J 15/0683; B25J 15/0625

(57) ABSTRACT

A grip member for a vacuum box includes a tubular body having a first section delimiting a cavity in which a hollow piston is slidingly mounted, a first chamber of variable volume, into which a compressed air conduit opens, the piston being provided with a tubular extension having a free end section projecting from the first cavity and provided with a suction cup, the piston and the tubular extension defining a suction channel having an end which opens into the suction cup and an opposite end which slidingly, sealingly receives a rod, the tubular extension including a suction orifice to connect the suction channel to a second chamber under negative pressure, and the piston being movably mounted in translation with respect to the rod between a rest position in which the rod blocks the suction orifice and a gripping position in which the rod is recessed from the suction orifice.

The present invention relates to the field of handling by vacuum.

The invention more specifically relates to a grip member for a vacuum box, and a device for gripping by vacuum, comprising such a box.

### BACKGROUND OF THE INVENTION

Devices for gripping by vacuum are used in numerous industrial fields (automotive, pharmaceutical industry, etc.), for example to move or handle parts in a production chain. They generally comprise a vacuum box comprising a lower panel (commonly called baseplate) provided with suction cups. Each suction cup comprises a metal body having a first end section fastened in a perforation of the plate and a second end section extending outside of the plate and carrying a deformable rubber skirt. Suction cups are intended to simultaneously grip a part when the air contained inside the box is suctioned through a vacuum generator.

Each particular gripping application has its own constraints. Indeed, the parts that are able to handle such boxes are of variable shape, weight and size. Boxes must therefore be manufactured so as to respond to the particular constraints in which they are used.

For clear performance reasons, it is not desirable that one of the suction cups does not contribute to gripping the part and continues to suction air, while the other suction cups hold the part. Thus, a box cannot be adapted to move an object of a smaller size than that for which it has been sized.

What is more, it cannot be necessary to use all of the suction cups to move an object which is lighter than that for which it has been sized.

### Aim of the Invention

The invention therefore aims to propose a grip member for a vacuum box, making it possible to at least partially prevent the abovementioned disadvantages.

### SUMMARY OF THE INVENTION

To this end, according to the invention, a grip member for a vacuum box is proposed, comprising a tubular body which comprises a first section delimiting a first cavity in which a first hollow piston is slidingly mounted, defining with walls of the first cavity, a first chamber of variable volume, into which a compressed air conduit opens.

The first piston is provided, opposite the first chamber, with a tubular extension having a free end section projecting from the first cavity and provided with a suction cup. The first piston and the tubular extension define a suction channel having an end which opens into the suction cup and an opposite end which slidingly, sealingly receives a rod. The tubular extension comprises at least one first suction orifice to connect the suction channel to a second chamber under negative pressure.

The first piston is movably mounted in translation with respect to the rod between a rest position in which the rod blocks the first suction orifice and a gripping position in which the rod is recessed from the first suction orifice.

It is thus possible to control each of the grip members of a vacuum box independently from one another and therefore to adapt the number of grip members used to move an object in question.

Particularly, the first piston, the tubular extension and the rod are coaxial.

Particularly, the first piston is returned to its rest position by a first spring.

Particularly, the tubular body comprises a compressed air supply channel having an end opening into the first chamber and an opposite end opening to the outside of the tubular body.

Particularly, the tubular body comprises at least one second suction orifice having an end opening into the second chamber and an opposite end opening to the outside of the tubular body.

According to a particular feature of the invention, the tubular body comprises a second section delimiting a second cavity in which a second piston is mounted, defining with walls of the second cavity, a third chamber and a fourth chamber arranged to be connected respectively to the compressed air source and to the ambient air. The rod is secured to the second piston and defines with said second piston, a delivery channel having an end opening into the suction channel and an opposite end opening into the third chamber. The second piston is movably mounted in translation between a rest position in which the rod is recessed from the suction orifice of the first piston in the rest position, and a deposition position in which the rod blocks the suction orifice.

Particularly, the first piston and the second piston are coaxial.

Particularly, the second piston is returned to its rest position by a second spring.

The invention also relates to a vacuum box equipped with at least one such grip member.

The invention further relates to a device for gripping by vacuum comprising such a box.

### BRIEF DESCRIPTION OF THE DRAWINGS

The invention can be better understood in the light of the following description, which is purely illustrative and non-limiting, and should be read with reference to the accompanying drawings, in which:

FIG. 1 is an axial cross-sectional view of a grip device according to a particular embodiment of the invention;

FIG. 2A is an axial cross-sectional view of the device illustrated in FIG. 1, before gripping the object;

FIG. 2B is a view identical to FIG. 2A, during gripping the object;

FIG. 2C is a cross-sectional view identical to FIG. 2A, during the deposition of the object;

FIG. 2D is a cross-sectional view identical to FIG. 2A, after the deposition of the object.

### DETAILED DESCRIPTION OF THE INVENTION

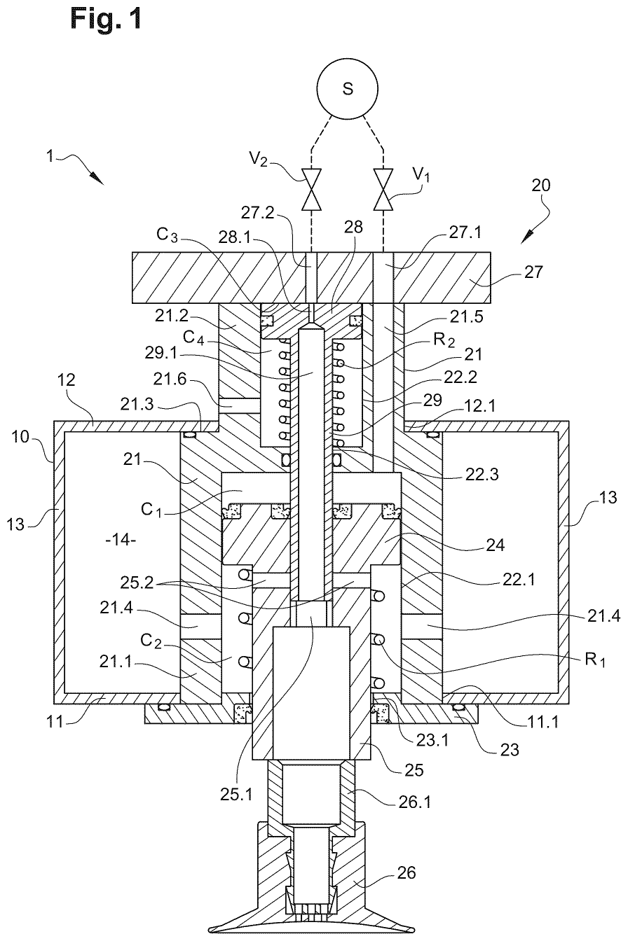

In reference to FIG. 1, a device for gripping by vacuum, generally referenced 1, comprises a vacuum box 10 in which a plurality of members 20 for gripping by vacuum is mounted (only one of the grip members 20 is represented).

The box 10 comprises a lower panel 11, an upper panel 12 and side panels 13 connecting the lower panel 11 to the upper panel 12 to form a sealed enclosure 14. The enclosure 14 has, in this case, a rectangular parallelepiped shape and is intended to be connected to a vacuum generating source (not represented).

The lower panel 11 and the upper panel 12 comprise respectively first orifices 11.1 and second orifices 12.1 for receiving the grip members 20. The first orifices 11.1 and the second orifices 12.1 are circular-shaped, each of the second orifices 12.1 extending, in this case, coaxially facing one of the first orifices 11.1. The first orifices 11.1 have, in this case, a diameter greater than that of the second orifices 12.1.

Each of the grip members 20 comprises a tubular body 21 having a central axis X substantially perpendicular to the lower panel 11 and to the upper panel 12. The tubular body 21 is mainly cylindrically-shaped and comprises externally a shoulder 21.3 delimiting a first section 21.1 and a second section 21.1 of said tubular body 21. The first section 21.1 and the second section 21.2 are received as a snug fit respectively in one of the first orifices 11.1 and in the corresponding second orifice 12.1. The shoulder 21.3 is in sealed contact with an internal face of the upper panel 12.

The first section 21.1 extends inside of the box 10 and comprises a first bore 22.1 opening onto a free end of the first section 21.1. The second section 21.2 extends to the outside of the box 10, projecting from an external face of the upper panel 12, and comprises a second bore 22.2 opening onto a free end of the second section 21.2. The first bore 22.1 and the second bore 22.2 extend along the axis X and are coaxial.

The tubular body 21 also comprises a third bore 22.3, coaxial to the first bore 22.1 and to the second bore 22.2, connecting a bottom of said first bore 22.1 to a bottom of the second bore 22.2. The free end of the first section 21.1 receives a holding plate 23 in the position of said first section 21.1 in the box 10. The holding plate 23 and the first bore 22.1 together define a first cavity inside which a first piston 24 is slidingly mounted along the axis X. The first piston 24 defines, with the walls of the first cavity, a first chamber C₁ and a fourth chamber C₂, both of variable volume.

The first section 21.1 comprises suction orifices 21.4 having an end opening into the second chamber C₂ and an opposite end opening into the box 10. The suction orifices 21.4 are, in this case, symmetrically and evenly distributed about the axis X, in one same plane perpendicular to the axis X.

The tubular body 20 also comprises a channel 21.5 for supplying the first chamber C₁ with compressed air. The supply channel 21.5 extends along an axis substantially parallel to the axis X, and comprises an end opening into the first chamber C₁ and an opposite end opening into a first compressed air supply orifice 27.1 provided in the plate 27. The first supply orifice 27.1 has an end opening into the supply channel 21.5 and an opposite end intended to be selectively connected to the compressed air source S via a first solenoid valve V₁ controlled, for example, by an automaton or an electronic board (not represented).

The first piston 24 is hollow and is provided with a tubular extension 25 which extends along the axis X from a lower face of the first piston 24 and which sealingly passes through a circular opening 23.1 provided in the holding plate 23, such that a free end section of the tubular extension 25 extends to the outside of the box 10, projecting from an external face of the lower panel 11. The first piston 24 and the tubular extension 24 delimit a suction channel 25.1 extending along the axis X. The suction channel 25.1 has an end connected to a gripping suction cup 26 which is fastened to the free end section of the tubular extension 25 via an insert 26.1.

The tubular extension 25 comprises suction orifices 25.2 having an end opening into the suction channel 25.1 and an opposite end opening into the second chamber C₂. The suction orifices 25.2 are, in this case, symmetrically and evenly distributed about the axis X, in a plane perpendicular to the axis X.

The free end of the second section 21.2 receives a plate 27 for connecting to a blower device. The plate 27 and the second bore 22.2 together define a second cavity inside which a second piston 28 is slidingly mounted along the axis X. The second piston 28 defines, with the walls of the second cavity, a third chamber C₃ and a fourth chamber C₄, both of variable volume.

The plate 27 comprises a second compressed air supply orifice 27.2 having an end opening into the third chamber C₃ and an opposite end intended to be selectively connected to a compressed air source S via a second solenoid valve V₂ controlled by the automaton or the electronic board (not represented). The second section 21.2 comprises a venting orifice 21.6 having an end opening into the fourth chamber C₄ and an opposite end opening to the outside of the box 10.

The second piston 28 is provided with a rod 29 which extends along the axis X, from a lower face of the second piston 28, and which sealingly passes through the third bore 22.3 such that a free end section of the rod 29 extends into the first bore 22.1. The free end section of the rod 29 is slidingly, sealingly received in the suction channel 25.1 delimited by the first piston 24 and the tubular extension 25.

The rod 29 is hollow and delimits, with the second piston 28, a compressed air delivery channel 29.1 having an end opening into the suction channel 25.1 and an opposite end opening into the third chamber C₃ via a compressed air delivery orifice 28.1 provided on an upper face of the second piston 28. It will be noted that the delivery orifice 28.1 has a diameter less than that of the second supply orifice 27.2 of the plate 27, which is itself less than that of the delivery channel 29.1 of the rod 29. Indeed, as long as one of the delivery orifice 28.1 and the delivery channel 29.1 has a diameter less than that of the second supply orifice 27.2, the diameter of the other of the delivery orifice 28.1 and the delivery channel 29.1 is of little importance (the diameter of the delivery orifice 28.1 can be equal to that of the delivery channel 29.1).

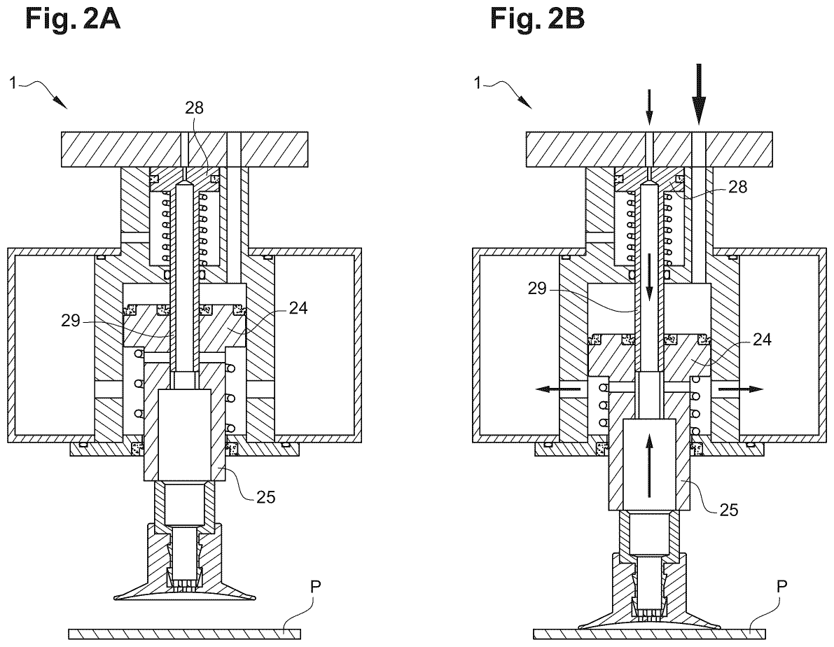

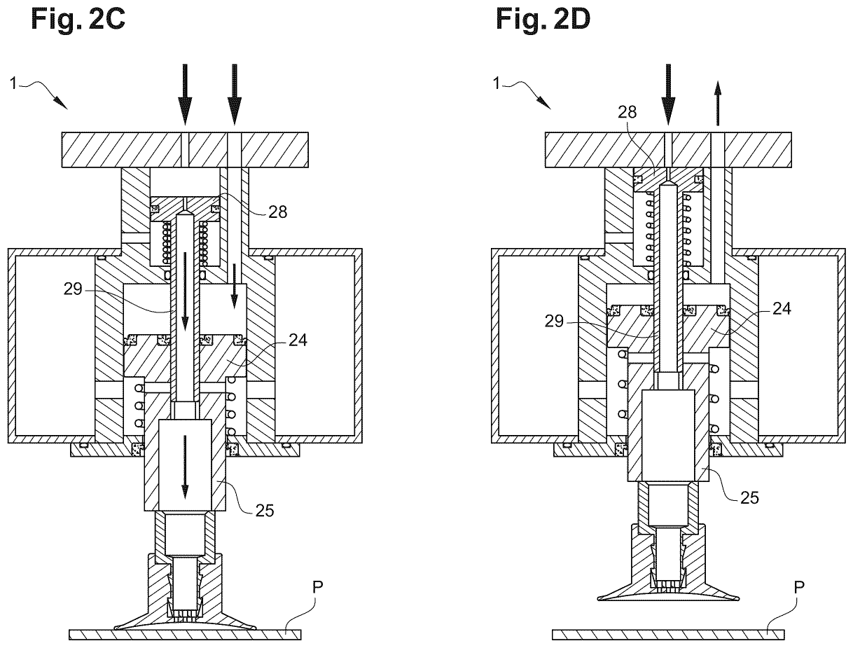

The first piston 24 is slidingly mounted between a so-called rest high position in which an upper face of the first piston 24 is closed to the bottom of the first bore 22.1 (FIGS. 1, 2A and 2D), and a so-called gripping low position in which the upper face of the first piston 24 is away from the bottom of the first bore 22.1 (FIGS. 2B and 2C). The first piston 24 is returned to the high position by a first helical spring R₁ surrounding the tubular extension 25. The first spring R₁ has an end bearing against an internal face of the holding plate 23 and the lower face of the first spring R₁.

The second piston 28 is slidingly mounted between a so-called rest high position in which the upper face of the second piston 28 is in contact with a lower face of the plate 27 (FIGS. 1, 2A, 2B and 2D), and a so-called deposition low position in which the upper face of the second piston 28 is away from the plate 27 (FIG. 2C). The second piston 28 is returned to the high position by a second helical spring R₂ surrounding the rod 29. The second spring R₂ has an end bearing against the bottom of the second bore 22.2 and an opposite end bearing against the lower face of the second piston 28.

The free end section of the rod 29 is arranged, such that:
when the first piston 24 and the second piston 28 are both in the high position (FIGS. 1, 2A and 2D) or in the low position (FIG. 2C), the end section of the rod 29 totally blocks the suction orifices 25.2 of the tubular extension 25, such that the suction cup 26 is not fluidically connected to the box 10; and
when the first piston 24 is in the low position and the second piston 28 is in the high position (FIG. 2B), the end section of the rod 29 is recessed from the suction orifices 25.2, such that the suction cup 26 is fluidically connected to the box 10.

The operation of the grip member 20 will now be detailed with reference to FIGS. 2A to 2D.

While the first solenoid valve V₁ and the second solenoid valve V₂ are in the closed state, the box 10 carrying the grip member 20 is brought above an object P to be moved, for example via a robotic handling arm (not represented), such that the suction cup 26 of the grip member 20 is spaced apart from the object P by a distance slightly less than the stroke of the first piston 24 (FIG. 2A).

The first solenoid valve V₁ is then brought from the closed state to the open state, such that the compressed air is blown into the first chamber C₁, which has the effect of passing the first piston 24 from the high position to the low position (FIG. 2B). The suction cup 26 thus bears against an upper surface of the object P and is now fluidically connected to the vacuum box 10, the end section of the rod 29 no longer blocking the suction orifices 25.2 of the tubular extension 25. It is understood that the suction cup 26 exerts a suction force on the upper surface of the object P, which causes a gripping by vacuum of the object P via said suction cup 26.

It will also be noted that it is possible to measure the vacuum at the second supply orifice 27.2 of the plate 27, this measurement being representative of the suction force exerted by the suction cup 26.

While the first solenoid valve V₁ is held in the open state, the box 10 is brought via the robotic arm, above the support on which the object P must be deposited, such that the object P is spaced apart from the support by a distance less than a predetermined distance. The second solenoid valve V₂ is then brought from the closed state to the open state, such that the compressed air is blown into the third chamber C₃, which has the effect of passing the second piston 28 from the high position to the low position (FIG. 2C). The end section of the rod 29 thus totally blocks the suction orifices 25.2 of the tubular extension 25, and the compressed air blown into the third chamber C₃ via the second support orifice 27.2 passes through the delivery channel 29.1 and arrives in the suction cup 26. It is thus understood that the object P is blown and that it will thus fall through gravity on the support, the suction cup 26 thus no longer exerting any suction force on the object P.

Once the object P is deposited on the support, the robotic arm performs a retracting movement making it possible to move the suction cup 26 away from the object P. While the second solenoid valve V₂ is held in the open state, the first solenoid valve V₁ is brought from the open state to the closed state, such that, under the action of the first spring R₁ and of the second spring R₂, the first piston 24 and the second piston 28 pass substantially simultaneously from the low position to the high position. The second solenoid valve V₂ is finally brought from the open state to the closed state, the grip member 20 being ready again for another gripping by vacuum.

It will be noted that:
the different grip members 20 carried by the box 10 can be controlled independently from one another, which makes it possible to only use some of the grip members 20 to move an object (in particular, according to the dimensions of the object P, to its size, to its weight, etc.);
the passing of the first piston 24 from the high position to the low position makes it possible to avoid the suction cups 26 of the unused grip members 20 coming into contact with the object P to be handled;
the passing of the second piston 28 from the high position to the low position makes it possible to selectively and asynchronously deposit objects P; and
the first spring R₁ and the second spring R₂ make it possible respectively to ensure the raising of the first piston 24 and of the second piston 28 while preserving the blowing of compressed air into the suction cup 26 in order to limit the risk of self-suction by the suction cup 26 when the robotic arm cannot ensure a retracting movement after depositing the object P.

Naturally, the invention is not limited to the embodiments described, but includes any variant entering into the scope of the invention such as defined by the claims.

The box 10 can only carry one single grip member 20.

The first solenoid valve V₁ and the second solenoid valve V₂ can be replaced by any device making it possible to selectively connect the first supply orifice 27.1 and the second supply orifice 23.2 to the compressed air source S.

The first supply orifice 27.1 and the second supply orifice 27.2 of the plate 27 can be connected to distinct compressed air sources.

The second piston 28 is optional. The rod 29 is thus fastened with respect to the tubular body 20 and the object P is thus deposited only through gravity as soon as the suction cup 26 is no longer fluidically connected with the vacuum box 10, i.e. when the first solenoid valve V₁ is brought from the open state to the closed state. In the case where it is necessary to blow compressed air into the suction cup 26 to deposit the object P, a reversing valve can be mounted on the vacuum generator connected to the box 10 in order to alternate vacuum and pressure in the enclosure 14 of said box 10.

A check valve can be added to the second piston 28 in order to avoid a compressed air intake into the enclosure 14 of the box 10 during the passing from the closed state to the open state of the second solenoid valve V₂.

1. A grip member for a vacuum box, comprising a tubular body which comprises a first section delimiting a first cavity in which a first hollow piston is slidingly mounted, defining with walls of the first cavity, a first chamber of variable volume, into which a compressed air conduit opens,
the first piston being provided, opposite the first chamber, with a tubular extension having a free end section projecting from the first cavity and provided with a suction cup, the first piston and the tubular extension defining a suction channel having an end which opens into the suction cup and an opposite end which slidingly, sealingly receives a rod,
the tubular extension comprising at least one first suction orifice to connect the suction channel to a second chamber under negative pressure and
the first piston being movably mounted in translation with respect to the rod between a rest position in which the rod blocks the first suction orifice and a gripping position in which the rod is recessed from the first suction orifice.

2. The grip member according to claim 1, wherein the first piston, the tubular extension and the rod are coaxial.

3. The grip member according to claim 1, wherein the first piston is returned to its rest position by a first spring.

4. The grip member according too claim 1, wherein the tubular body comprises a compressed air supply channel having an end opening into the first chamber and an opposite end opening to the outside of the tubular body.

5. The grip member according too claim 1, wherein the tubular body comprises at least one second suction orifice having an end opening into the second chamber and an opposite end opening to the outside of the tubular body.

6. The grip member according to claim 1, wherein the tubular body comprises a second section delimiting a second cavity in which a second piston is mounted, defining with walls of the second cavity, a third chamber and a fourth chamber arranged to be connected respectively to the compressed air source and to the ambient air,
the rod being secured to the second piston and defining with said second piston, a delivery channel having an end opening into the suction channel and an opposite end opening into the third chamber, and
the second piston being movably mounted in translation between a rest position in which the rod is recessed from the suction orifice of the first piston in the rest position, and a deposition position in which the rod blocks the suction orifice.

7. The grip member according to claim 6, wherein the first piston and the second piston are coaxial.

8. The grip member according to claim 6, wherein the second piston is returned to its rest position by a second spring.

9. A vacuum box equipped with the grip member according to claim 1.

10. A device for gripping by vacuum comprising a box according to claim 9.
